(19) United States
(12) Patent Application Publication
(10) Pub. No.: US 2010/0100449 A1
(43) Pub. Date: Apr. 22, 2010

(54) METHOD AND SYSTEM OF ADVERTISING WITHOUT ADDING TAGS TO CONTENT STREAMS

(75) Inventors: David K. Broberg, Lafayette, CO (US); Judson D. Cary, Denver, CO (US); Gregory Allen Broome, Broomfield, CO (US); Clarke Stevens, Littleton, CO (US)

Correspondence Address: BROOKS KUSHMAN P.C., 1000 TOWN CENTER, TWENTY-SECOND FLOOR, SOUTHFIELD, MI, 48075, US

(73) Assignee: Cable Television Laboratories, Inc., Louisville, CO (US)

(21) Appl. No.: 12/255,708

(22) Filed: Oct. 22, 2008

(51) Int. Cl. G06Q 30/00

(52) U.S. Cl. 705/14.68

(57) ABSTRACT

A method and system of advertising that facilitates an automated advertisement process where a user, at any point during playback, simply makes a request to view an advertisement and an advertisement related to the current point of playback is automatically provided. The advertisement can be related to a scene showing proximate in time to the request so that the user can specify what type of advertisement is provided and when it is provided.

### BACKGROUND OF THE INVENTION

1. Field of the Invention

The present invention relates to facilitating user-requested advertising, such as but not limited to facilitating user-requested advertising without having to embed tags or other identifiers within content streams used to deliver content to advertisement recipients.

2. Background Art

Much of today's content can be provided electronically through some form of analog and/or digital, wireline and/or wireless content streaming. Content owners can use these electronic mediums to transmit content to large numbers of customers. Some of the content owners may rely on service providers to facilitate the content deliveries. The service providers may be multiple system operators (MSOs), such as but not limited to cable, satellite, or broadcast television providers, or other operators having subscribers or customers that rely on their communication network and support to facilitate content deliveries.

The service providers, in turn, may rely on advertisers to defray the costs of supporting networks and other expenditures required to facilitate electronic content deliveries. In some cases, the service provider may force viewing of particular advertisements by actually embedding the advertisement within the related content stream. One example relates to actually splicing an advertisement within the content stream, such as by inserting a television commercial into a commercial break of a television program. Another example relates to overlaying or otherwise providing icons that appear during access, such as by programming an application or other feature to display on-screen icon in a portion of a screen during non-commercial breaks.

Advertisers gain some advantage by these and other methods of displaying their advertisements. A greater advantage can be achieved if the users are actually able to select the advertisement and/or to request additional information for products being advertised, such as coupons, store locations, customer support phone numbers, etc. These types of user-directed actions may require ‘upstream’ communications to the service provider and/or advertiser. Some user-access devices are able to the support the necessary upstream communications.

The upstream communications, however, are only useful if the user-access devices are able to identify the advertisement or item for which additional information is requested. This problem has been overcome by embedding advertisement tags or other advertisement identifiers within the content streams. When the user sees an item of interest, the related tag can be captured from the content stream and included within a request for additional advertisement information. The tags can then be cross-referenced with the related product, advertiser, etc. to facilitate subsequent delivery of the advertisement related information.

Some form of processing of the content stream may be performed to embed the advertisement tag within the content stream. This can be problematic since it requires content providers, service providers, and other entities responsible for supporting content delivery to embed the additional information. For providers that support larger geographical areas, this may require different areas to re-process or processing content differently in order to insure tags are embedded that properly cross-reference to a related local advertiser.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a system for supporting advertising in accordance with one non-limiting aspect of the present invention;

FIG. 2 illustrates a method for supporting advertising in accordance with one non-limiting aspect of the present invention.

### DETAILED DESCRIPTION OF THE PREFERRED EMBODIMENT(S)

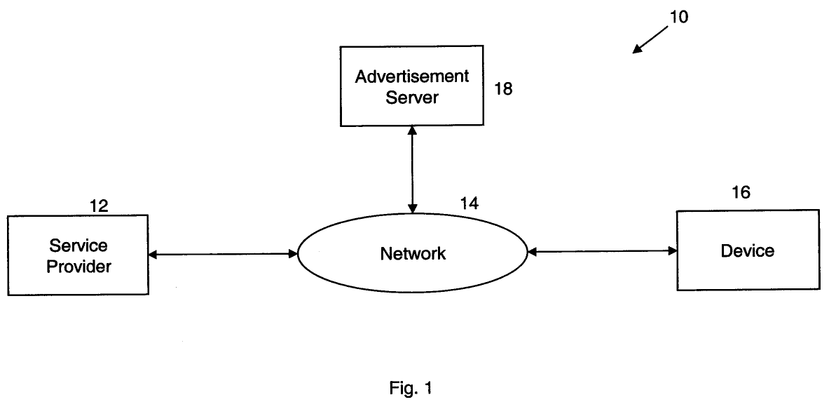

FIG. 1 illustrates a system 10 configured to facilitate user-directed advertising in accordance with one non-limiting aspect of the present invention. The system 10 is generally described with respect to facilitating advertising in electronic mediums where content is provided from a content/service provider 12 over a wireless or wireline network 14 for receipt by a device 16 that processes the content for output to a user. The system 10 is predominately described with respect to facilitating advertisement delivery while a user is viewing content delivered through the system 10. For exemplary purposes, the content is often referred to as a television program. This is done without intending to limit the scope and contemplation of the present invention.

The present invention fully contemplates its use and application in other electronic content delivery systems, and not just television transmission environments. One non-limiting aspect of the present invention contemplates facilitating on-demand, user-directed advertisement delivery without having to embed advertisement tags or other unique identifiers within television signals transmitted to the device. The ability to support on-demand advertising without having to embed tags within the transmitted television signals can be helpful in limiting processing demands on the service provider.

The present invention contemplates applying the same savings to other environments where it may be beneficial to facilitate on-demand advertising without having to embed supporting data with the signals used to deliver the related content. These other environments may include but are not limited to audio transmission, VoIP transmission, video conferencing, interactive gaming, etc.

The exemplary embodiment shown in FIG. 1 includes the service provider 12 electronically transmitting content to the user by way of the network 14 and related output device 16. The service provider 12 may be a multiple system operator (MSO), such as but not limited to a broadcast, cable, or satellite television service provider. The service provider 12 may receive content from any number of content providers, studios, and other owners (not shown). The service provider 12 may re-package the content for transmission to any number of users (subscribers). A single network 14 and device 16 is shown for exemplary purposes but it is contemplated that the service provider 12 may support users throughout a large geographical area. Additional networks, headends, routers, etc. may be used by the service provider and/or network to facilitate electronically transmitting the re-packaged content.

The service provider 12 may re-package the content by encrypting, scrambling, or otherwise processing it according to the configuration requirements of the network 14. An advertisement server 18 may be used to select advertisements for inclusion within the transmitted content. The advertisements may be provided by advertisers and added to the content according to any number of advertisement methodologies. The advertisements may be spliced into the content streams and/or shown as icons or other features during playback of the content. The content may include avails or other designations where advertisement are desired, such as for designating a commercial break wherein an advertisement may be inserted and/or for prompting an application on the device to overlay a user-targeted advertisement or an advertisement icon.

The use of these and other types of advertisements, by either directly adding them to the content stream or forcing their viewing through pop-ups, may be helpful in assuring user viewing. One non-limiting aspect of the present invention contemplates an arrangement where the user may interact with the forced-viewed advertisements and/or to request advertisement when there are no advertisements being shown. For the purposes of the present invention, a user initiated request to interact with an advertisement and/or to request an advertisement is referred to as an advertisement request.

The advertisement request may be a request for additional information and/or a request to view an actual advertisement. In the case of the advertisement a request actually relating to a request for additional information, the user may desire a booklet, flyer, coupon, customer support contact information, website link, etc. for a currently viewed advertisement or other stimulus. In the case of a request to view an actual advertisement, the user may desire viewing of an advertisement related to the currently viewed content, such as an advertisement for clothing articles that an actress is currently wearing, a location where a scene is taking place, etc. In this manner, the present invention contemplates the user initiating an advertisement request, i.e., a request for an actual advertisement and/or additional information, in response to viewing advertisements, pop-up icons, scene location/props, and/or other stimulants.

The user may actuate a remote control (not shown) or other feature to transmit the advertisement request to the device 16. The device may in turn relay the request to the advertisement server 18 and/or the service provider 12. The advertisement server 18, which may be part of the service provider 12 and/or a separate entity, may then provide the advertisement or other information desired by the user (referred to as the advertisement). This may include transmitting the advertisement to the device 16 for playback and/or storage. If the device 16 is settop box (STB) used to process television signals for output to the television, the advertisement may be stored on the STB or at the headend for subsequent viewing and/or the currently showing program may be interrupted for immediate viewing of the advertisement, optionally with the programming being buffered at the headend or with a time-shift buffer in the STB (DVR).

The advertisement may be transmitted through other means, such as but not limited to email, registered email, Instant Messaging (IM), Short Messaging Service (SMS), and or Multimedia Messaging Service (MMS). The advertisement may be sent to another device besides the device used to access the content, such as a computer, mobile phone, appliance, etc. and/or through other non-electronic mediums, such as U.S. Mail or other parcel delivery services, which may be helpful in transmitting products offered for sale in advertisements or otherwise orderable through user request.

The advertisement request may be a request for additional information, and in some cases, a request to order a product shown in a scene or advertised in a commercial. A user request to purchase the program may be inferred from receipt of a one-click request to deliver the product determined through actuation of a remote control purchase button or other feature (mouse). This single ‘click’ may be used to instigate purchase and delivery of the product, which may be automatically identified from form an advertisement or scene showing during its receipt. Instructions may be automatically issued to a seller that are sufficient for the seller to ship the product to an address associated with the user and/or to bill either a provider of the media program or the user for the delivered product.

The present invention contemplates multiple reasons for initiating an advertisement or product request and multiple mediums for delivering the requested information. One non-limiting aspect of the present invention contemplates facilitating delivery of the requested advertisement without reliance on advertisement tags or other information embedded within the content stream. This may allow the device 16 or another device to properly issue the advertisement request without having to capture data from the content stream.

One non-limiting aspect of the present invention contemplates the requesting device 16 collecting non-content stream specific information to facilitate identifying the advertisement desired by the user. The service provider 12 and/or the advertisement server 18 may include a database that cross-references advertisements with content available to the requesting device. This database may allow the proper advertisement to be selected from the collected information. For example, the requesting device may identify the tuned-to channel and a time of day at which the request was determined. This information may be cross-referenced with known programming information to identify the related advertisement.

To facilitate the advertisement selection process, particular portions of each program may be associated with an avail, optionally in addition to or in place of the avails already associated with commercial breaks and pop-up advertisements. The number, frequency, and duration of the avails may vary depending on events occurring within the content. Time-stamps, elapse-time, and other non-content stream specific markers may be used to reference the avails without having to add corresponding tags to the related content stream. By simply referencing the elapse time at which the content related to the advertisement request was received and the channel that was being watched, the database can identify a related avail. An advertiser purchasing an opportunity to air an advertisement during the identified avail may then transmit an advertisement to the targeted destination as defined by the requesting device 16.

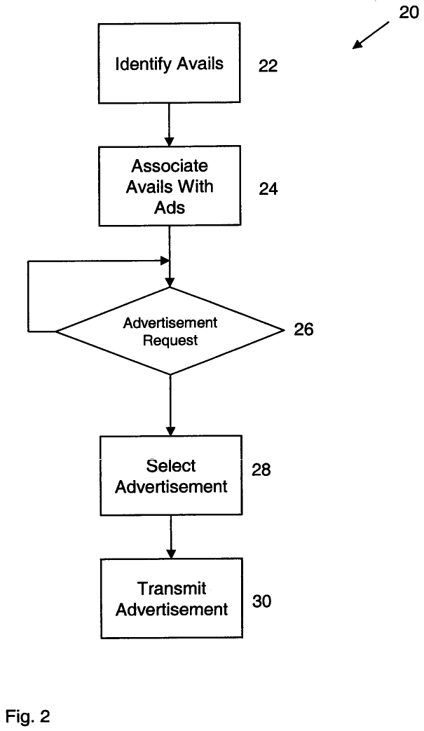

FIG. 2 illustrates a flowchart 20 of a method of advertising in accordance with one non-limiting aspect of the present invention. The method is described with respect to linear (broadcast) and non-linear (on-demand, switched, DVR, etc.) transmissions of television programs and facilitating selection of advertisement for playback upon user demand. The method may apply to other content delivery schemes and is not intended to be limited to television signal transmissions.

Block 22 relates to determining avails. For a particular television program, typically before the program is transmitted, a number of opportunities may be identified as being suitable to particular advertisements. The suitability of the avails may relate to an elapse time, context of a scene, props, and other stimulants that may prompt a viewer to become interested in a product or service provided by an advertiser. Some programs may have more avails than others depending on the nature of the content. Rather than separately embedding data within the content stream to identify the avails, such as by tagging, one non-limiting aspect of the present invention contemplates identifying them according to a timestamp and channel ID, session ID, or other independent reference point that can determined by the device, or a server used to support playback (VOD), without reliance on information carried within the content stream.

Block 24 relates to associating the avails with one or more advertisements. Prior to or after the program begins its transmission, a promotional group of the service provider may offer the avails for purchase to advertisers. An ad from the purchasing advertiser can be scheduled to run during advertisement requests received for the corresponding avail. If multiple advertisers purchase the same avail, depending on the transmission technique, multiple advertisements may be transmitted and/or an algorithm may select one of the advertisements that better matches with the viewing characteristics of the user believed to be watching the program. The avails may be considered to be non-embedded references to portions of each transmitted program for which advertisements may be assigned and requested.

Block 26 relates to determining an advertisement request. The advertisement request may be instigated by the user and received from the device used to watch the program or through some other element having capabilities sufficient to support upstream communications with the service provider and/or advertisement server. Prior to transmitting the request, information may be collected regarding circumstance proximate in time to when the request was initiated. The collected information may be gleaned from conditions tracked on the device, such as the time of day, elapsed time within the program and channel or session ID being watched in addition to subscriber identification information. The information may be included in the request to facilitate identify the appropriate avail.

Block 28 relates to processing the information included in the advertisement to select the desired advertisement. This may include cross-referencing the collected information against the avails to determine the avail occurring closest in time to receipt of the request so that the one or more advertisements previously associated with the avail may be transmitted to the device. Since the selected advertisement is not directly linked to information embedded with the content stream, the associated advertisement can be changed after the program begins to transmit by simply changing the advertisement cross-referenced to the related avail.

Block 30 relates to transmitting the selected advertisement. The advertisement may be transmitted to the device used to initiate the request and/or to another device. The transmission of the advertisement may be dependent on the advertisement and a device ID optionally included within the request. Some advertisements, such as those used to display television ads, may be delivered to a STB for playback on the display, and other advertisements, such as those providing a web link to more information or a coupon, may be delivered to a computer or mobile device.

As supported above, one non-limiting aspect of the present invention relates to a system and process that enables real-time, context sensitive advertising for multichannel programming using a two-way link between a service provider and subscriber. An application on the client receiving device may sense a special button push, key press or mouse click from the viewer during any particular program. This application can send the viewer's current time/date/channel information to the headend to identify the subscriber and potentially Geolocation data or other viewer identification data from connected devices. In the case of time-shifted or recorded content, the current elapsed time for the program being viewed along with the start time can be processed by the application to provide the effective backdated time/date information, as if the user made the request from the live program. This method can avoid the need to use a special “Transaction-ID” tag embedded within the content.

An application running on a server can be designed to capture the upstream reports from the subscriber at the content distribution point or some intermediate point. The upstream application can capture the user-data and cross-reference it to a database of advertisers who have purchased link-avails on a time/channel/program basis (during programs and during ads.) This database can allow a single (or multiple) advertiser(s) to purchase the links for any given program down to a minute-by-minute/second-by-second basis. This enables advertisers to purchase ads for movie soundtracks, songs, and on-screen product placements in TV shows, including such things as local dealerships for national product ads, etc.

Once the upstream server application has matched the time/date/channel tags to a given (or multiple) advertisers, the matching advertiser's link, offer or message can then be sent to the subscriber's registered email, or Instant Messaging (IM) address, and/or mobile device using Short Messaging Service (SMS) or Multimedia Messaging Service (MMS) automatically. Finally, the user can click on the link, read the offer or print a coupon as needed from their computer, which correlates to the product, service. Optionally, the links or data points can be added to a special page on the user's personal MSO web account. Besides allowing the user to keep his e-mail/IM address private, this also allows the MSO to use normal web-site affiliate programs with the referring URL registered to the MSO. Optionally, the links may be added to a personal page in the set-top box software. When the user navigates to this page, the links can be used to launch an OCAP application, start a VoD ad, etc.

One non-limiting aspect of the present invention enables multichannel program distributors to sell a new form of interactive advertising to their subscribers. It may avoid the need to do any real-time processing of the video content. In addition, it may allow ads to be dynamically selected and updated in real-time without ever needing to process the video content. By avoiding the content tagging function, the system requires the multichannel programming provider to purchase only a single headend server to host the application rather than all the special data insertion gear needed for each and every transport stream they carry. This lowers the cost of entry substantially. Another advantage to this approach is all programming can be immediately for sale even at the most local level—there is no need to wait until custom tags are inserted. Furthermore, this system can enable advertising down to the most local level rather than pushing the advertising upstream to the content origination or national distribution point since the cost of inserting the transaction-ID tags used by other systems is dramatically higher the further downstream they are inserted and this tends to be cost prohibitive for local applications.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

What is claimed is:

1. A method of advertising comprising:
upon receiving an advertisement request from a device used to process television signals for output to a display, transmitting an advertisement to the device that relates to content showing on the display proximate in time to receipt of the advertisement request; and
relating the transmitted advertisement to content showing on the display proximate in time to receipt of the advertisement request based on information included within the advertisement request, wherein the information included with the advertisement request is determined without reliance on advertisement data tagged to a content stream used to transmit the television signals.

2. The method of claim 1 further comprising, if the content stream is linear, relating the advertisement to the content showing on the display from a channel ID that identifies a channel currently tuned to by the device and time of day occurring proximate in time the receipt of the advertisement request.

3. The method of claim 1 further comprising, if the content stream is non-linear, relating the advertisement to the content showing on the display from a session ID that identifies a session used to transmit the content stream to the device and an elapse time that represents a duration expiring from a beginning of the non-linear content stream to a point in time occurring proximate to receipt of the advertisement request.

4. The method of claim 1 further comprising receiving the advertisement request in response to the device receiving a request message from a user watching the display.

5. The method of claim 2 wherein the device is a settop box (STB) and the method further comprises receiving the request message from an application operating on the STB.

6. The method of claim 1 further comprising selecting the transmitted advertisement from geolocation data gleaned from the request message and a genre of a program showing proximate in time to receipt of the advertisement request.

7. The method of claim 1 further comprising selecting the transmitted advertisement after a start time of a program showing on the display.

8. The method of claim 1 further comprising providing the transmitted advertisement by including the advertisement within a message sent to second device, the second device being different from the device output signals to the display.

9. The method of claim 1 wherein the advertisement is one of a product offered in a commercial showing on the display proximate in time to receipt of the advertisement request or a booklet, flyer or coupon for another product related to content showing on the display proximate in time to receipt of the advertisement request.

10. A method of advertising comprising:
identifying avails within a content stream;
associating advertisements to the avails without adding advertisement tags to the content stream;
receiving an advertisement request message from a user device accessing the content stream, the advertisement request message indicating a need to transmit an advertisement not already being carried within the content stream; processing information included within the advertisement request to identify an avail occurring proximate in time to when the need to transmit the advertisement was determined; and
transmitting the advertisement tagged to the identified avail.

11. The method of claim 10 further comprising transmitting the content stream to the user device without providing any indicia within the content stream that identifies the avail.

12. The method of claim 10 further comprising identifying the avails according to an interval of time elapsing since a beginning of playback of the content stream.

13. The method of claim 12 further comprising determining the identified avail from a time-stamp included within the advertisement request message.

14. The method of claim 10 further comprising changing the advertisement associated with the avail used to trigger transmission of the advertisement after the content stream begins transmitting.

15. A method of advertising comprising:
transmitting an advertisement to a device for playback after a program related to the advertisement has already begun to play;
selecting the advertisement to relate to a stimulus provided by the program proximate in time to receiving an advertisement request; and
identifying the stimulus from an elapse time of the program occurring proximate in time to receipt of the advertisement request and without retrieving a stimulus identifying tag from a content stream used to transmit the program.

16. The method of claim 15 further comprising transmitting the content stream to a second device that is separate from the device used to play the advertisement.

17. The method of claim 15 further comprising attaching stimulus identifying tags to the content stream used to transmit the program.

18. The method of claim 15 farther comprising pausing playback of the program to permit playback of the advertisement.

19. The method of claim 15 further comprising, if the content stream is linear, identifying the stimulus from a channel ID of a currently tuned to television channel and the elapse time.

20. The method of claim 15 further comprising, if the content stream is non-linear, identifying the stimulus from a session ID that identifies a session used to transmit the content stream and the elapse time.

21. A method of facilitating delivery of a product associated with one of a scene, advertisement or other stimulus temporarily provided during playback of a multimedia program, the method comprising
upon receiving a one-click request to deliver the product and without relying on advertising avails tagged to the multimedia program, identifying the product associated with the one of the scene, advertisement or other stimulus from operating settings of a device used to facilitate playback of the multimedia program to a user requesting delivery of the product; and
facilitating delivery of the identified product without requiring the user to issue additional commands beyond the one-click request used to identify the product.

22. The method of claim 21 further comprising facilitating delivery of the identified product by issuing instructions to a seller of the product that are sufficient for the seller to ship the product to an address associated with the user and to bill one of a provider of the media program or the user for the delivered product.

23. The method of claim 21 further comprising facilitating delivery of the identified product by issuing instructions to an advertiser associated with the product to ship promotional materials to the user.

24. The method of claim 21 further comprising determining the one-click request in response to the device receiving a single signal representative of single user input to the device occurring proximate in time to one of the scene, advertisement or other stimulus.

25. The method of claim 21 further comprising identifying the program solely from a device ID, program ID and elapse time ID transmitted from the device.
